(19) United States
(12) Patent Application Publication
(10) Pub. No.: US 2022/0206891 A1
(43) Pub. Date: Jun. 30, 2022

(54) ERROR HANDLING METHOD AND APPARATUS

(71) Applicant: LENOVO ENTERPRISE SOLUTIONS (SINGAPORE) PTE. LTD., SINGAPORE (SG)

(72) Inventors: LUNG-HSING TING, TAIPEI CITY (TW); MING-HO HU, NEW TAIPEI CITY (TW); FU-CHENG DENG, TAOYUAN CITY (TW); JING-WEN HUANG, TAIPEI CITY (TW)

(21) Appl. No.: 17/565,159

(22) Filed: Dec. 29, 2021

(30) Foreign Application Priority Data
Dec. 31, 2020 (CN) 202011637532.8

(51) Int. Cl. G06F 11/07

(52) U.S. Cl. CPC G06F 11/0793; G06F 11/0706; G06F 11/079

(57) ABSTRACT

An error handling method performed by a computing device, the computing device comprises at least one computing device component and a board management controller (BMC) coupled to the at least one computing device component, the method comprises the steps of a BMC detecting an error relating to at least one computing device component, the BMC determining from a database a technical specification to fix the error and generating information for accessing the technical specification. An error handling apparatus comprises a BMC and at least one computing device component coupled to the BMC. The BMC is configured to detect an error relating to the at least one computing device component, determine from in a database a technical specification to fix the error, and generate information for accessing the technical specification.

### TECHNICAL FIELD

The present disclosure relates to an error handling method, apparatus and computing system and in particular, to an error handling method and an error handling apparatus in a computing system and a computing system incorporating an error handling apparatus

### BACKGROUND

A Board Management Controller (BMC) in a computing system such as a computer server is configured to handle system errors relating to components of the computing system, for example, a Central Processing Unit (CPU), a memory card, and connection interfaces etc. A BMC in conventional computing systems uses check log Light Emitting Diode (LED)s and system error LEDs to notify a user in an event of a system error taken place. The user will have to separately contact a call center for further information associated with the system error, e.g. a problem management record (PMR), to obtain a possible technical solution to fix the error. Such a process is both time-consuming and incurs additional costs chargeable by the call center. It is therefore desirable to provide a method, apparatus and system for efficiently handling computing system errors without reliance on a call center.

### SUMMARY

In one aspect, the present disclosure provides an error handling method performed by a computing device. The computing device comprises at least one computing device component and a board management controller (BMC) coupled to the at least one computing device component. The method comprises the BMC detecting an error relating to a computing device component, the BMC determining from a database a technical specification to fix the error; and the BMC generating information for accessing the technical specification.

In another aspect, the present disclosure provides an error handling apparatus for a computing device. The apparatus includes a board management controller (BMC) and at least one computing device component coupled to the BMC. The BMC is configured to detect an error relating to the at least one computing device component, determine from a database a technical specification to fix the error, and generate information for accessing the technical specification.

### BRIEF DESCRIPTION OF DRAWINGS

The features of the embodiments will be more comprehensively understood in conjunction with the accompanying drawings, in which:

FIG. 1 is a block diagram showing an error handling apparatus according to one embodiment of the present disclosure.

FIG. 2 is a block diagram showing a computing system according to one embodiment of the present disclosure.

FIG. 3 is a block diagram showing an error handling apparatus according to another embodiment of the present disclosure.

FIG. 4 is a block diagram showing a computing system according to another embodiment of the present disclosure.

FIG. 5 is a flow chart showing an error handling method according to one embodiment of the present disclosure.

### DETAILED DESCRIPTION

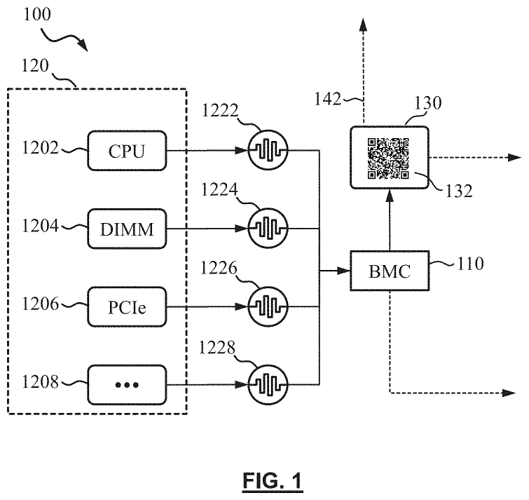

In one aspect, the present disclosure provides an error handling apparatus and a computing system. According to one embodiment as shown in FIG. 1, an error handling apparatus 100 includes a Board Management Controller (BMC) 110 and one or more components 120 coupled to the BMC 110. The one or more components 120 may be parts, functional modules or assemblies of a computing device. For example, components 120 may include a Central Processing Unit (CPU) 1202, a Dual In-line Memory Module (DIMM) 1204, a Peripheral Component Interconnect Express (PCIe) interface 1206, and any other types of parts, functional modules or assemblies 1208 of a computing device.

Each of the components 1202, 1204, 1206 and 1208 is configured to generate a respective error signal 1222, 1224, 1226 and 1228 in an event that the component has a system error encountered therein, and the BMC 110 is configured to detect the error and receive such error signal 1222, 1224, 1226 and 1228 from the components 1202, 1204, 1206 and 1208.

The BMC 110 is coupled to a database 150. The database 150 may be a cloud-based storage space remotely connected to the BMC 110, or a device or facility in data communication with the BMC 110 via other types of connections e.g. local network or the like. The database 150 has a collection of technical specification/technical documents such as problem management reports 152, 154, etc. stored therein. Each technical document contains information used to manage any product issue or system error each of the components may encounter during the operation of the computing device, based on the configuration of the computing device and historical problem reporting and solution information. For example, each technical document may contain information corresponding to each type of system error a computing device may encounter, as represented by respective error signals 1222, 1224, 1226 and 1228.

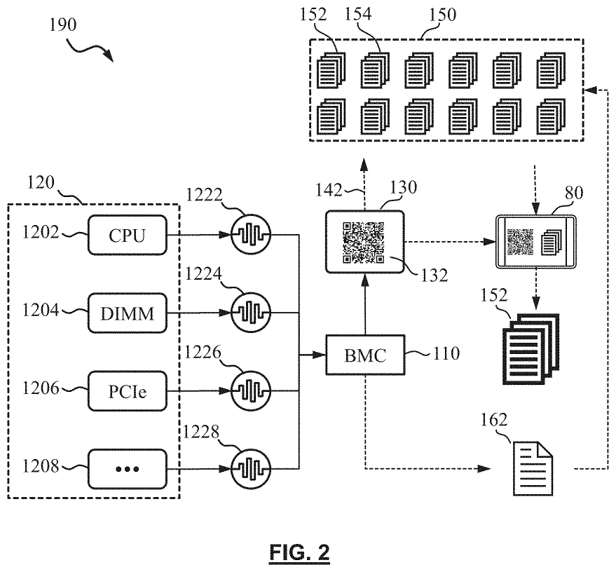

According to another aspect, as shown in FIG. 2, a computing system 190 according to one embodiment of the present disclosure includes a BMC 110, one or more computing device components such as a CPU 1202, a DIMM 1204, a PCIe interface 1206 and other components 1208 coupled to the BMC 110, and a database 150 coupled to the BMC 110. The database 150 has technical documents 152, 154 etc. stored therein. Each technical document contains information used to manage any product issue or system error each of the components may encounter during operation of the computing device, based on the configuration of the computing device and historical problem reporting and solution information.

With reference to the apparatus 100 shown in FIG. 1 and in conjunction with the system 190 shown in FIG. 2, in an event of any one of more of the components 120 has a system error encountered therein, for example in cases where the CPU 1202 encounters a system error, the error is detected by the BMC 110 and a first error signal 1222 from the CPU 1202 is generated and received by the BMC 110. Upon receipt of the first error signal 1222, the BMC 110 determines that a technical document 152 in the database 150 contains detailed information corresponding to the first error signal 1222, with respect to the nature, historical record and root cause of the error encountered by the CPU 1202. The technical document may also contain information related to a solution e.g. a Problem Determination and Service Guide (PDSG) to fix the error. Upon determining the technical document 152, the BMC 110 provides a link 142 for accessing the technical document 152 in the database 150.

For example, the BMC 110 generates an image 132 with the link 142 encoded therein, and the apparatus 100 includes a screen 130 coupled to the BMC 110 to display the image 132. The image 132 may be a QR code or the like which is capable of being read or scanned by a reader or remote device 80. Upon being read or scanned, the image 132 is transmitted into the reader or remote device 80 from which, a user e.g. a service personnel obtains the technical document 152 from the database 150 through the link 142 retrieved from the image, and takes necessary actions to figure out the root cause of the system error encountered by the CPU 1202, and fix the system error according to guide and information provided by the technical document 152 as obtained.

After the system error is fixed, the BMC 110 generates a service log 162 which includes a description of the error encountered by the CPU 1202, the error signal 1222 received from the CPU 1202 representing the error, the technical solution and procedure provided by the technical document 152 and implemented to fix the system error, according to the action taken based on the technical document 152. The BMC 110 uploads the service log 162 to the database 150 and the records of the technical document 152 is updated in the database 150.

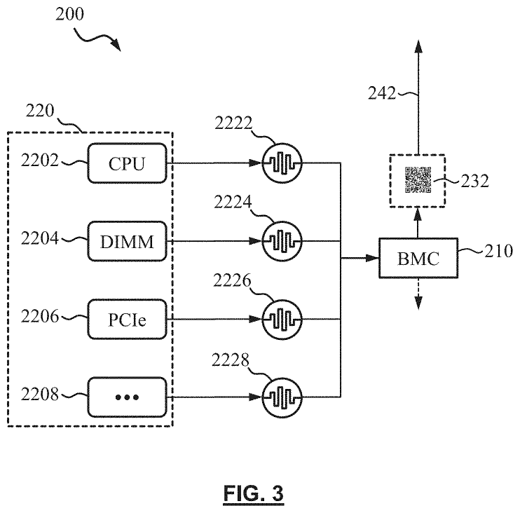

According to another embodiment, as shown in FIG. 3, an error handling apparatus 200 includes a BMC 210 and one or more components 220 coupled to the BMC 210. The one or more components 220 may be parts, functional modules or assemblies of a computing device. For example, components 220 may include a CPU 2202, a DIMM 2204, a PCIe interface 2206, and any other types of parts, functional modules or assemblies 2208 of a computing device.

Each of the components 2202, 2204, 2206 and 2208 is configured to generate a respective error signal 2222, 2224, 2226 and 2228 in an event that the component has a system error encountered therein, and the BMC 210 is configured to detect the error and receive such error signal 2222, 2224, 2226 and 2228 from the components 2202, 2204, 2206 and 2208.

The BMC 210 is in data communication with a website 250. The website 250 has a collection of technical specification/technical documents such as problem management reports 252, 254, etc. stored therein, and a graphical user interface (GUI) 251 displaying the website 250. Each technical document contains information used to manage any product issue or system error each of the components may encounter during operation of the computing device, based on the configuration of the computing device and historical problem reporting and solution information. For example, each technical document may contain information corresponding to each type of system errors a computing device may encounter, as represented by respective error signals 2222, 2224, 2226 and 2228.

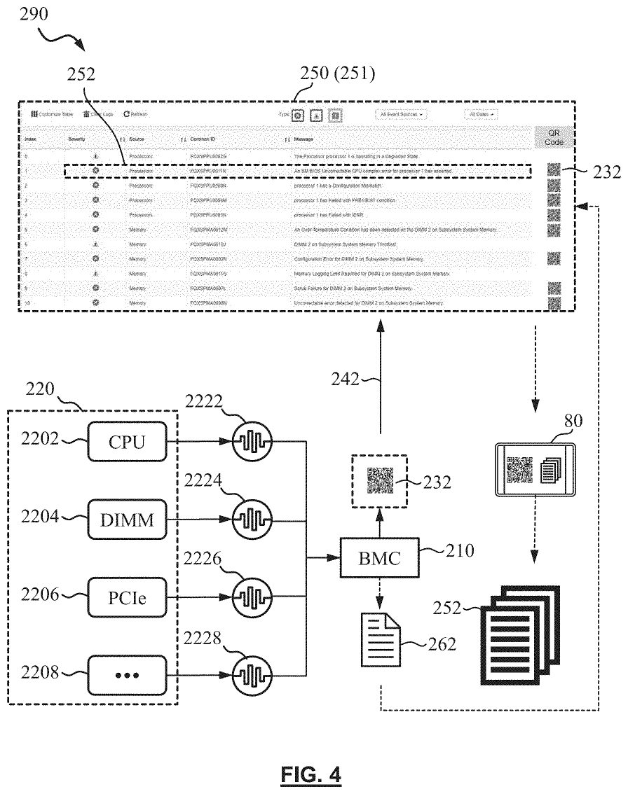

As shown in FIG. 4, a computing system 290 according to another embodiment of the present disclosure includes a BMC 210, one or more computing device components such as a CPU 2202, a DIMM 2204, a PCIe interface 2206 and other components 2208 coupled to the BMC 210, and a website 250 coupled to the

BMC 210. The website 250 has technical documents such as problem management reports 252, 254 etc. stored therein, and a graphical user interface (GUI) 251 displaying the website 250. Each technical document contains information used to manage any product issue or system error each of the components may encounter during operation of the computing device, based on the configuration of the computing device and historical problem reporting and solution information.

With reference to the apparatus 200 shown in FIG. 3 and in conjunction with the system 290 shown in FIG. 4, in an event of any one or more of the components 220 has a system error encountered therein, for example in cases where the CPU 2202 encounters a system error, the error is detected by the BMC 210 and a first error signal 2222 from the CPU 2202 is generated and received by the BMC 210. Upon receipt of the first error signal 2222, the BMC 210 determines that a technical document 252 in the website 250 contains detailed information corresponding to the first error signal 2222, with respect to the nature, historical records and root cause of the error encountered by the CPU 2202, as well as a solution e.g. a Problem Determination and Service Guide (PDSG) to fix the error. The BMC 210 provides a link 242 for accessing the technical document 252 in the website 250.

For example, the BMC 210 generates an image e.g. a QR code 232 with the link 242 encoded therein, uploads the QR code 232 to the website 250 and displays the QR code 232 in a list of technical documents including the technical document 252 as determined to correspond to the first error signal 2222, and with the QR code 232 shown on the same row of the corresponding technical document 252 in the list.

The website 250 is made accessible to a user e.g. a service personnel. The QR code 232 is capable of being read or scanned by a reader or remote device 80 operated by the user. Upon being read or scanned, the QR code 232 is transmitted into the reader or the remote device 80, from which, the user obtains the technical document 252 from the website 250 through the link 242, and take necessary actions to figure out the root cause of the system error encountered by the CPU 2202, and fix the system error according to the guide and information provided by the technical document 252 as obtained.

After the system error is fixed, the BMC 210 generates a service log 262 which includes a description of the error encountered by the CPU 2202, the error signal 2222 received from the CPU 2202 representing the error, the technical solution provided by the technical document 252 and implemented to fix the system error, according to the action taken based on the technical document 252. The BMC 210 uploads the service log 262 to the website 250 to enable the technical document 252 in the website 250 to be updated based on the service log 262.

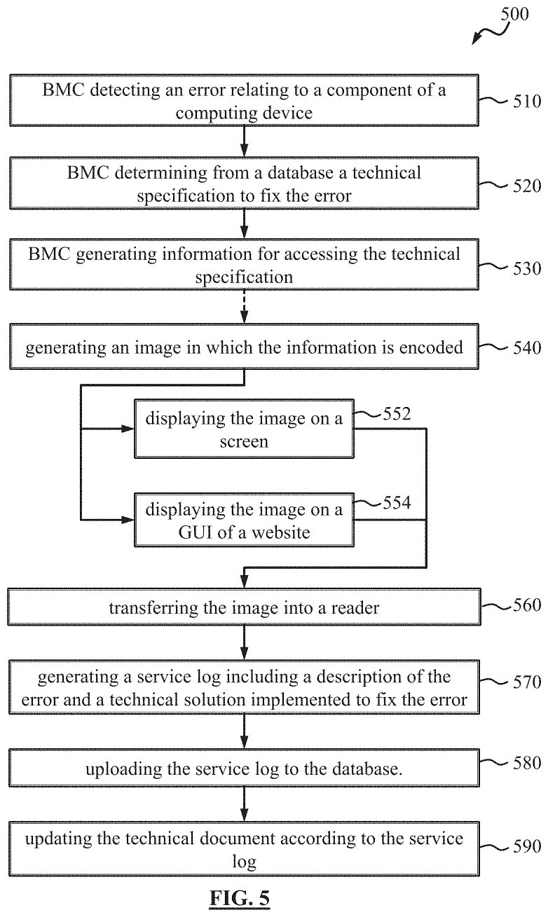

In another aspect, the present disclosure provides an error handling method. According to one embodiment as shown in FIG. 5, an error handling method 500 includes, at step 510, a BMC detecting an error relating to a component of a computing device. The error may be associated with a system error encountered by the component. The component may be a part, a functional module or an assembly of a computing device. For example, the component may include a CPU, a DIMM, a PCIe interface card, or any other types of parts, functional modules or assemblies of a computing device.

At step 520, the BMC determines from a database a technical specification to fix the error. The database maybe a cloud-based storage space or a website connected to the BMC, in which a collection of technical specification/documents such as problem management reports are stored. Each technical document contains information used to manage any product issue or system error which may be encountered by each of the components during operation of the computing device, based on the configuration of the computing device and historical problem reporting and solution information.

At step 530, the BMC generates an information for accessing the technical specification in the database or the website.

The BMC generating information for accessing the technical specification may include providing a link to access the technical specification. The method may include, at step 540, generating an image e.g. a QR code with the information for accessing the technical specification encoded therein, and at step 552, the method displays the image on a screen. Alternatively, the method may display the image on a GUI of a website at step 554

At step 560, the method transmits the image into a reader or a remote device of a user e.g. a service personnel. Upon the error being fixed based on the information provided by the technical document, the method generates, at step 570, a service log which includes a description of the error and a technical solution implemented to fix the error. Upon the service log being generated, the method uploads, at step 580, the service log onto the database and further at step 590, to update the technical document in the database.

As used herein, the singular “a” and “an” may be construed as including the plural “one or more” unless clearly indicated otherwise.

The present disclosure has been presented for purposes of illustration and description but is not intended to be exhaustive or limiting. Many modifications and variations will be apparent to those of ordinary skill in the art by the teachings of the present disclosure. The example embodiments have been chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be effected therein by one of ordinary skill in the art without departing from the scope of the disclosure as defined in the claims appended hereto.

1. An error handling method performed by a computing device comprising at least one computing device component and a board management controller (BMC) coupled to the at least one computing device component, the method comprising the steps of:
the BMC detecting an error relating to the at least one computing device component;
the BMC determining from a database technical information to fix the error; and
the BMC generating information for accessing the technical specification.

2. The method of claim 1, wherein the BMC generating information for accessing the technical information includes providing a link to access the technical specification.

3. The method of claim 2, further comprising a step of displaying an image on a screen coupled to the computing device, wherein the link is encoded in the image.

4. The method of claim 2, further comprising the step of displaying an image on a Graphic User Interface of a website connected to the computing device, wherein the link is encoded in the image.

5. The method of claim 3, further comprising the step of transmitting the image into a reader to access the technical specification for fixing the error.

6. The method of claim 5 further comprising, after the error is fixed, the step of generating a service log, which includes a description of the error and the technical specification to fix the error.

7. The method of claim 6 further comprising the step of uploading the service log to the database.

8. The method of claim 7 further comprising the step of updating the technical specification according to the service log.

9. An error handling apparatus for a computing device, the apparatus comprising:
a board management controller (BMC);
at least one computing device component coupled to the BMC;
wherein the BMC is configured to:
detect an error relating to the at least one computing device component;
determine from a database technical information to fix the error; and
generate information for accessing the technical specification.

10. The apparatus of claim 9, wherein the BMC is further configured to provide a link to access the technical specification.

11. The apparatus of claim 10, further comprising a screen coupled to the BMC to display the link.

12. The apparatus of claim 11, wherein the BMC is configured to generate a service log after the error is fixed, wherein the service log includes a description of the error and the technical specification to fix the error.

13. The apparatus of claim 12, wherein the BMC is configured to upload the service log to the database.
